(19) United States
(12) Patent Application Publication
(10) Pub. No.: US 2015/0211873 A1
(43) Pub. Date: Jul. 30, 2015

(54) NAVIGATION TILES WITH CITY INFORMATION

(71) Applicant: Hajime Yamada, Rancho Palos Verdes, CA (US)

(72) Inventor: Hajime Yamada, Rancho Palos Verdes, CA (US)

(73) Assignee: HONDA MOTOR CO., LTD., Tokyo (JP)

(21) Appl. No.: 14/167,177

(22) Filed: Jan. 29, 2014

(51) Int. Cl. G01C 21/34

(52) U.S. Cl. CPC G01C 21/343

(57) ABSTRACT

A projected route between a first location and a second location is determined. A plurality of milestones is identified along the projected route. Milestone-to-milestone navigation information is presented to a user. The plurality of milestones includes at least one of a cross street and a border. The milestone-to-milestone navigation information includes the plurality of milestones.

### BACKGROUND

The present disclosure relates generally to navigation systems and, more particularly, to methods and systems for use in planning a trip.

At least some known navigation systems identify a projected route between a first location and a second location, and present turn-by-turn navigation instructions to a user. As the name might suggest, turn-by-turn navigation instructions include a plurality of steps that include a plurality of turns along the projected route. For example, turn-by-turn navigation instructions may include: “turn right onto A Street in X miles” or “turn left onto B Avenue in Y miles.”

### BRIEF SUMMARY

In one aspect, a computer-implemented method is provided for planning a trip. The method includes determining a projected route between a first location and a second location, identifying a plurality of milestones along the projected route, and presenting milestone-to-milestone navigation information to a user. The plurality of milestones includes at least one of a cross street and a border. The milestone-to-milestone navigation information includes the plurality of milestones.

In another aspect, a computer-readable storage media having computer-executable instructions embodied thereon is provided. When executed by a processor, the computer-executable instructions cause the processor to determine a projected route between a first location and a second location, identify at least one border along the projected route, and present milestone-to-milestone navigation information to a user. The plurality of milestones includes the at least one border along the projected route.

In yet another aspect, a computing device is provided. The computing device includes a processor, and a computer-readable storage media having computer-executable instructions embodied thereon. When executed by the processor, the computer-executable instructions cause the processor to determine a projected route between a first location and a second location, identify a plurality of milestones along the projected route, and present a plurality of tiles to a user. Each tiles of the plurality of tiles is associated with a respective milestone of the plurality of milestones.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a schematic illustration of an exemplary computing system for planning a trip in accordance with one aspect of the present disclosure;

FIG. 2 is a schematic illustration of a map including a first location, a second location, and a projected route between the first location and the second location in accordance with one aspect of the present disclosure;

FIGS. 3 and 4 are exemplary screenshots of milestone-to-milestone navigation information that may be presented using the computing system shown in FIG. 1 in accordance with one aspect of the present disclosure; and

FIG. 5 is a flowchart of an exemplary method that may be implemented by the computing system shown in FIG. 1 in accordance with one aspect of the present disclosure.

Although specific features of various embodiments may be shown in some drawings and not in others, this is for convenience only. Any feature of any drawing may be referenced and/or claimed in combination with any feature of any other drawing.

### DETAILED DESCRIPTION

The present disclosure relates generally to navigation systems and, more particularly, to methods and systems for use in planning a trip. In one embodiment, a projected route between a first location and a second location is determined, and a plurality of milestones is identified along the projected route. Milestone-to-milestone navigation information including the plurality of milestones is presented to a user. The plurality of milestones includes at least one of a cross street and a border. For example, milestone-to-milestone navigation instructions may indicate that a user will cross A Street in X miles, enter B City in Y miles, and/or see C point-of-interest site in Z miles.

An exemplary technical effect of the methods and systems described herein may include at least one of: (a) determining a projected route between a first location and a second location; (b) identifying at least one milestone type of a plurality of milestone types; (c) identifying a plurality of milestones along the projected route; (d) identify at least one region associated with at least one milestone of the plurality of milestones; (e) determining a distance between the first location and the second location; (f) determining a distance between the first location and a first milestone of the plurality of milestones; (g) determining a distance between the first milestone and a second milestone of the plurality of milestones; (h) determining a time between the first location and the second location; (i) determining a time between the first location and the first milestone; (j) determining a time between the first milestone and the second milestone; (k) presenting a map including a first indicator associated with the first location, a second indicator associated with the second location, a third indicator associated with the projected route, and a fourth indicator associated with at least one milestone of the plurality of milestones; (l) presenting a plurality of tiles including milestone-to-milestone navigation information to a user; (m) arranging the tiles based on a respective proximity of each milestone of the plurality of milestones to the first location and/or the second location; (n) dynamically updating the milestone-to-milestone navigation information based on a change to the first location and/or the second location; (o) dynamically updating the milestone-to-milestone navigation information based on a change in a respective proximity of each milestone of the plurality of milestones to the first location and/or the second location; and/or (p) toggling between a milestone-to-milestone navigation system and a turn-by-turn navigation system.

As used herein, an element or step recited in the singular and proceeded with the word “a” or “an” should be understood as not excluding plural elements or steps unless such exclusion is explicitly recited. Moreover, references to “one embodiment” and/or the “exemplary embodiment” are not intended to be interpreted as excluding the existence of additional embodiments that also incorporate the recited features.

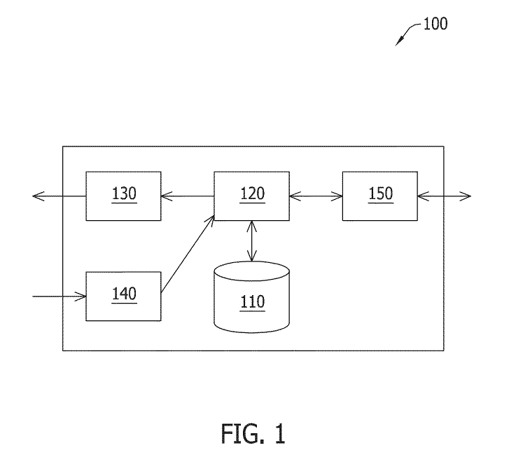

FIG. 1 is a schematic illustration of an exemplary computing system 100 for use in planning a trip. As used herein, the term “trip” refers to any act of travelling from one location to another. In the exemplary embodiment, computing system 100 is a mobile device, such as a smartphone, tablet, a vehicle computer system, and the like. Alternatively, computing system 100 may be any device that enables computing system 100 to function as described herein. In the exemplary embodiment, computing system 100 includes a memory device 110 and a processor 120 coupled to memory device 110 for use in executing instructions. More specifically, computing system 100 is configurable to perform one or more operations described herein by encoding an operation as one or more executable instructions, storing the executable instructions in memory device 110, and executing the stored executable instructions using processor 120.

Processor 120 may include one or more processing units (e.g., in a multi-core configuration). As used herein, the term “processor” is not limited to integrated circuits referred to in the art as a computer, but rather broadly refers to a controller, a microcontroller, a microcomputer, a programmable logic controller (PLC), an application specific integrated circuit, and other programmable circuits.

In the exemplary embodiment, memory device 110 includes one or more devices (not shown) that enable information such as executable instructions and/or other data to be selectively stored and retrieved. In the exemplary embodiment, such data may include, but is not limited to, navigation data, vehicle data, operational data, and/or control algorithms. Alternatively, computing system 100 may be configured to use any algorithm and/or method that enable the methods and systems to function as described herein. Memory device 110 may also include one or more computer readable media, such as, without limitation, dynamic random access memory (DRAM), static random access memory (SRAM), a solid state disk, and/or a hard disk.

In the exemplary embodiment, computing system 100 includes a presentation interface 130 that is coupled to processor 120 for use in presenting information to a user. For example, presentation interface 130 may include a display adapter (not shown) that may couple to a display device (not shown), such as, without limitation, a cathode ray tube (CRT), a liquid crystal display (LCD), a light-emitting diode (LED) display, an organic LED (OLED) display, an “electronic ink” display, and/or a printer. In some embodiments, presentation interface 130 includes one or more display devices.

Computing system 100, in the exemplary embodiment, includes an input interface 140 for receiving input from the user. In the exemplary embodiment, input interface 140 receives information suitable for use with the methods described herein. Input interface 140 is coupled to processor 120 and may include, for example, a camera, a microphone, a joystick, a keyboard, a pointing device, a mouse, a stylus, a touch sensitive panel (e.g., a touch pad or a touch screen), a position and/or motion detector, and/or a sound detector. It should be noted that a single component, for example, a touch screen, may function as both presentation interface 130 and as input interface 140.

In the exemplary embodiment, computing system 100 includes at least one communication interface 150 that is coupled to processor 120. In the exemplary embodiment, communication interface 150 communicates with at least one remote device, such as another computing system 100. In one embodiment, communication interface 150 is a global positioning system (GPS) receiver module configured to provide additional navigation- and location-related wireless data to computing system 100. Communication interface 150 may use, without limitation, a wired network adapter, a wireless network adapter, and/or a mobile telecommunications adapter. A network (not shown) used to couple computing system 100 to the remote device may include, without limitation, the Internet, a local area network (LAN), a wide area network (WAN), a wireless LAN (WLAN), a mesh network, and/or a virtual private network (VPN) or other suitable communication means.

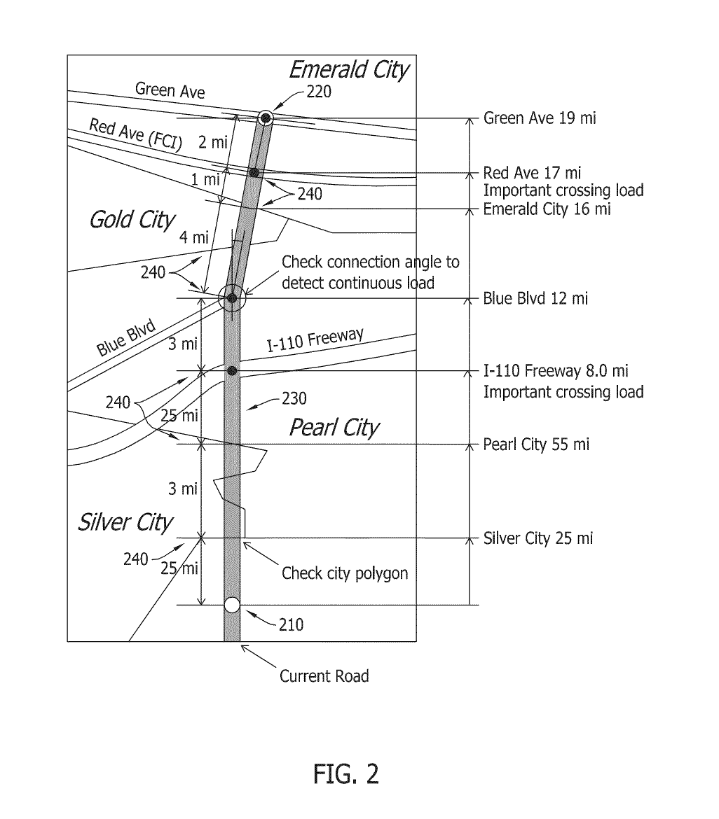

FIG. 2 is a schematic illustration of a map 200 including a first location 210 (e.g., a current location), a second location 220 (e.g., a destination), and a projected route 230 between first location 210 and second location 220. In the exemplary embodiment, at least one milestone 240 is between first location 210 and second location 220 along projected route 230. In one embodiment, milestones may include cross roads (i.e., roads that intersect projected route 230), borders (e.g., speed limit zones, neighborhood boundaries, city limits, state borders), and/or points of interest (e.g., monuments, hotels, restaurants, stadiums, buildings). Alternatively, milestones may be associated with any location along a projected route that enables computing system 100 to function as described herein.

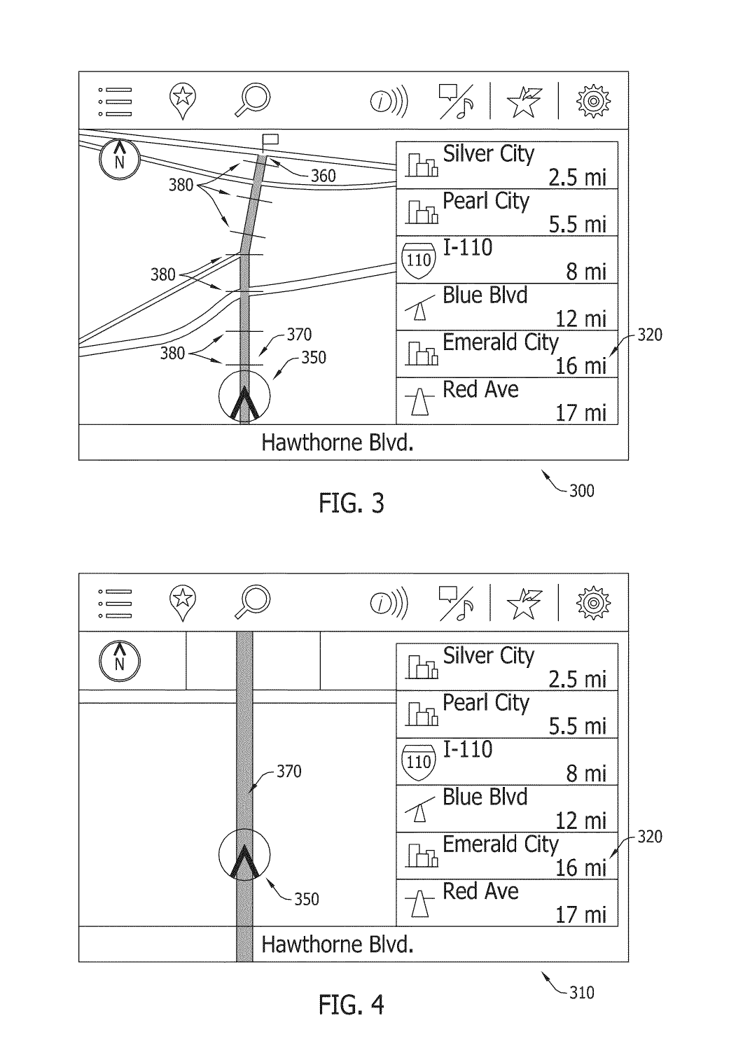

FIGS. 3 and 4 are exemplary screenshots 300 and 310 presented on presentation interface 130 (shown in FIG. 1). In the exemplary embodiment, each screenshot 300 and 310 includes a plurality of tiles 320 including at least one identified milestone. In the exemplary embodiment, tiles 320 are arranged and/or sorted based on a respective proximity of each milestone to first location 210 and/or second location 220 such that tiles 320 present milestone-to-milestone navigation information. In one embodiment, a tile associated with a milestone that is closer to first location 210 is presented before another tile associated another milestone that is farther from first location 210.

In at least some embodiments, presentation interface 130 is configured to present a predetermined number of tiles 320, and tiles 320 are dynamically updated based on a change in the position of each milestone with respect to first location 210 and/or second location 220. Alternatively, milestones 240 may be sorted based on any criteria and/or algorithm that enables computing system 100 to function as described herein.

In the exemplary embodiment, each screenshot 300 and 310 includes a map 330 and 340, respectively, including a first indicator 350 (e.g., an own-vehicle depiction) associated with first location 210 (shown in FIG. 2), a second indicator 360 (e.g., a checkered flag, shown in FIG. 3) associated with second location 220 (shown in FIG. 2), a third indicator 370 (e.g., a highlighted line) associated with projected route 230 (shown in FIG. 2), and/or a fourth indicator 380 (e.g., a highlighted line, shown in FIG. 3) associated with the at least one milestone 240 (shown in FIG. 2). In at least some embodiments, each type of milestone may be associated with a respective indicator. Alternatively, map 330 and/or 340 may include any subject matter that enables computing system 100 to function as described herein.

In the exemplary embodiment, computing system 100 is configured to “zoom out” by increasing a map scale to enable a user to see a larger area (as shown in FIG. 3) and/or “zoom in” by decreasing the map scale to enable the user to see a smaller area (as shown in FIG. 4). Alternatively, map 330 and/or 340 may be presented in any format that enables computing system 100 to function as described herein.

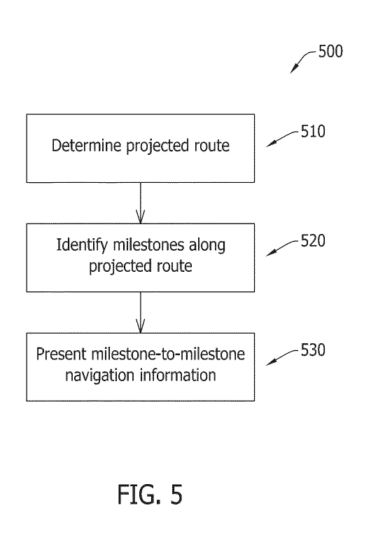

FIG. 5 is a flowchart of an exemplary method 500 that may be implemented by computing system 100 for planning a trip from first location 210 to second location 220. In the exemplary embodiment, computing system 100 is configured to identify and/or determine first location 210 and second location 220. In one implementation, first location 210 is determined based on a current position of a vehicle (e.g., via a GPS satellite system), and second location 220 is determined based on user input. For example, in such an implementation, second location 220 may be determined based on a user touching a point on a map displayed on a touch screen. Alternatively, first location 210 and/or second location 220 may be determined based on any criteria and/or algorithm that enables computing system 100 to function as described herein.

In the exemplary embodiment, computing system 100 is configured to calculate and/or determine 510 at least one projected route 230 between first location 210 and second location 220. In the exemplary embodiment, projected route 230 follows streets and/or roads between first location 210 and second location. In one embodiment, streets and/or roads are stored in memory device 110 and/or are retrieved from a remote server system (e.g., via a GPS satellite system). The streets and/or roads of projected route 230 may be determined based on parameters including, but not limited to, first location 210, second location 220, and user preferences including, without limitation, shortest route, fastest route, avoid highways, avoid toll roads, avoid ferries, and the like. Alternatively, projected route 230 may be determined using any criteria and/or algorithm that enables computing system 100 to function as described herein. Accordingly, computing system 100 is configured to plan a trip for the user.

In the exemplary embodiment, computing system 100 is configured to identify 520 at least one milestone 240 along projected route 230. In one embodiment, milestones 240 are stored in memory device 110 and/or are retrieved from a remote server system (e.g., via a GPS satellite system). In the exemplary embodiment, milestone 240 may be identified 520 based on parameters including, but not limited to, user preferences and/or input (e.g., a type of milestone). For example, if user input indicates a desire to see cross roads and borders, then computing system 100 identifies cross roads and borders along projected route 230. In one embodiment, when a user elects to see borders, computing system 100 identifies a plurality of borders along projected route 230 and may identify a first region on a first side of the border (e.g., a leaving city, or a region on projected route 230 closer to first location 210) and a second region on a second side of the border (e.g., an entering city, or a region on projected route 230 closer to second location 220). Alternatively, computing system 100 may be configured to identify any milestone based on any criteria and/or algorithm that enables computing system 100 to function as described herein.

In the exemplary embodiment, computing system 100 is configured to arrange and/or sort milestones 240 based on a respective proximity of each milestone to first location 210 and/or second location 220. In one embodiment, computing system 100 determines a first distance between a first milestone and first location 210, and determines a second distance between a second milestone and first location 210, the second milestone and the first milestone, and/or second location 220 and first location 210. Alternatively, computing system 100 may be configured to determine a first time between a first milestone and first location 210 (e.g., travel time from first location 210 to the first milestone), and determine a second time between a second milestone and first location 210 (e.g., an estimated travel time from first location 210 to the second milestone), the second milestone and the first milestone (e.g., an estimated travel time from first milestone to the second milestone), and/or second location 220 and first location 210 (e.g., an estimated travel time from first location 210 to second location 220). Distances and/or times may be determined and/or milestones 240 may be sorted based on any criteria and/or algorithm that enables computing system 100 to function as described herein. In at least some embodiments, computing system 100 is configured to dynamically determine distance and/or time based on changes to first location 210, second location 220, projected route 230, and/or milestones 240.

In the exemplary embodiment, computing system 100 is configured to present 530 a plurality of tiles 320 to a user. In the exemplary embodiment, each tiles 320 includes milestone information, such that tiles 320 include milestone-to-milestone navigation information. In the exemplary embodiment, tile 320 are arranged and/or sorted based on a respective proximity of each milestone to first location 210 and/or second location 220. In at least some embodiments, computing system 100 is configured to toggle between a milestone-to-milestone navigation system and a turn-by-turn navigation system, wherein each tiles 320 includes turn information associated with projected route 230. In at least some other embodiments, computing system 100 is configured to present tiles 320 associated with both milestone information and turn information.

In the exemplary embodiment, projected route 230 and/or milestones 240 are dynamically updated based on changes to first location 210 and/or second location 220. For example, as first location 210 changes (e.g., because a vehicle is moving), a new first location 210 is dynamically identified and a new projected route 230 is dynamically determined based on the new first location 210 and second location 220. For another example, when an original projected route is not followed (e.g., due to a wrong turn), computing system 100 determines 510 a new projected route and/or identifies at least one new milestone based on changes to a new first location 210. In the exemplary embodiment, projected route 230 and/or milestones 240 may be dynamically or iteratively determined and/or identified each time a new second location 220 is determined.

The embodiments described herein relate generally to navigation systems and, more particularly, to methods and systems for use in planning a trip. The embodiments described herein enable a user to plan and/or track a trip by looking for milestones such as cross roads and borders.

Exemplary embodiments of methods and systems for use in planning a trip are described above in detail. The methods and systems are not limited to the specific embodiments described herein, but rather, components of systems and/or steps of the method may be utilized independently and separately from other components and/or steps described herein. Each method step and each component may also be used in combination with other method steps and/or components. Although specific features of various embodiments may be shown in some drawings and not in others, this is for convenience only. Any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method for planning a trip, the method comprising:
determining a projected route between a first location and a second location;
identifying, using a processor, a plurality of milestones along the projected route, wherein the plurality of milestones includes at least one of a cross street and a border;
presenting, using a presentation interface, milestone-to-milestone navigation information to a user, wherein the milestone-to-milestone navigation information includes the plurality of milestones, wherein presenting milestone-to-milestone navigation information includes presenting a plurality of tiles to the user, each tile of the plurality of tiles associated with a respective milestone of the plurality of milestones, wherein each tile includes at least one of a first distance between the respective milestone and the first location and a first time associated with the first distance.

2. The computer-implemented method of claim 1 comprising, for each tile of the plurality of tiles presented to the user, determining the first distance between the respective milestone and the first location, and presenting the first distance to the user.

3. The computer-implemented method of claim 2 comprising determining a second distance between the second location and the first location, wherein presenting milestone-to-milestone navigation information comprises presenting the second distance to the user.

4. The computer-implemented method of claim 1 comprising, for each tile of the plurality of tiles presented to the user, determining the first time between the respective milestone and the first location, and presenting the first time to the user.

5. The computer-implemented method of claim 4 comprising determining a second time between the second location and the first location, wherein presenting milestone-to-milestone navigation information comprises presenting the second time to the user.

6. The computer-implemented method of claim 1 comprising identifying at least one milestone type of a plurality of milestone types, wherein identifying the plurality of milestones comprises identifying the plurality of milestones based on the at least one identified milestone type.

7. The computer-implemented method of claim 1 comprising presenting a map including a first indicator associated with the first location, a second indicator associated with the second location, a third indicator associated with the projected route, and a fourth indicator associated with at least one milestone of the plurality of milestones.

8. A non-transitory computer-readable storage media having computer-executable instructions embodied thereon, wherein, when executed by a processor, the computer-executable instructions cause the processor to:
determine a projected route between a first location and a second location;
identify a plurality of milestones along the projected route, wherein the plurality of milestones includes at least one border along the projected route;
present milestone-to-milestone navigation information to a user, wherein the milestone-to-milestone navigation information includes the at least one border along the projected route, wherein presenting milestone-to-milestone navigation information includes presenting a plurality of tiles to the user, each tile of the plurality of tiles associated with a respective milestone of the plurality of milestones, wherein each tile includes at least one of a first distance between the respective milestone and the first location and a first time associated with the first distance.

9. The computer-readable storage media of claim 8, wherein at least one tile of the plurality of tiles is associated with a first border of the at least one border, wherein the computer-executable instructions cause the processor to determine the first distance between the first border and the first location, the first distance presented to the user.

10. The computer-readable storage media of claim 9, wherein the computer-executable instructions cause the processor to determine a second distance between a second border of the at least one border and the first border, the second distance presented to the user.

11. The computer-readable storage media of claim 8, wherein at least one tile of the plurality of tiles is associated with a first border of the at least one border, wherein the computer-executable instructions cause the processor to determine the first time between the first border of the at least one border and the first location, the first time presented to the user.

12. The computer-readable storage media of claim 11, wherein the computer-executable instructions cause the processor to determine a second time between a second border of the at least one border and the first border, the second time presented to the user.

13. The computer-readable storage media of claim 8, wherein the computer-executable instructions cause the processor to identify at least one city associated with the at least one border, wherein the at least one city is presented to the user.

14. The computer-readable storage media of claim 8, wherein the computer-executable instructions cause the processor to present a map including a first indicator associated with the first location, a second indicator associated with the second location, a third indicator associated with the projected route, and a fourth indicator associated with at least one milestone of the plurality of milestones.

15. A computing device comprising:
a processor; and
a non-transitory computer-readable storage media having computer-executable instructions embodied thereon, wherein, when executed by the processor, the computer-executable instructions cause the processor to:
determine a projected route between a first location and a second location;
identify a plurality of milestones along the projected route;
present a plurality of tiles to a user, wherein each tile of the plurality of tiles is associated with a respective milestone of the plurality of milestones, and wherein each tile includes at least one of a first distance between the respective milestone and the first location and a first time associated with the first distance.

16. The computing device of claim 15, wherein the computer-executable instructions cause the processor to arrange the plurality of tiles based on a respective proximity of each milestone of the plurality of milestones to at least one of the first location and the second location.

17. The computing device of claim 15, wherein the computer-executable instructions cause the processor to dynamically update the plurality of tiles based on a change to at least one of the first location and the second location.

18. The computing device of claim 15, wherein the computer-executable instructions cause the processor to dynamically update the plurality of tiles based on a change in a respective proximity of each milestone of the plurality of milestones to at least one of the first location and the second location.

19. The computing device of claim 15, wherein the computer-executable instructions cause the processor to toggle between a milestone-to-milestone navigation system and a turn-by-turn navigation system.

20. The computing device of claim 15, wherein the computer-executable instructions cause the processor to identify at least one milestone type of a plurality of milestone types, wherein the plurality of milestones are identified based on the at least one identified milestone type.
